(19) United States
(12) Patent Application Publication
(10) Pub. No.: US 2022/0404019 A1
(43) Pub. Date: Dec. 22, 2022

(54) Portable Low Voltage Material Combustion System

(71) Applicant: Flash Fire LLC, Sheridan, WY (US)

(72) Inventor: Jesse A. Kloberdanz, Molalla, OR (US)

(73) Assignee: Flash Fire LLC, Sheridan, WY (US)

(21) Appl. No.: 17/352,577

(22) Filed: Jun. 21, 2021

(51) Int. Cl. F23Q 7/22; F02P 3/00; F02P 17/12; F02P 19/02

(52) U.S. Cl. CPC F23Q 7/22; F02P 3/00; F02P 17/12; F02P 19/021; F23N 2900/05005

(57) ABSTRACT

A portable low voltage material combustion system and methods of making and using the system including a non-transitory computer readable medium containing a program code executable to deliver an output voltage or an output current from the mobile computing device to an igniter which converts the output voltage or the output current into heat sufficient to ignite a primer composition to generate flame spread in associated combustible materials.

### I. FIELD OF THE INVENTION

A portable low voltage material combustion system and methods of making and using the system including a non-transitory computer readable medium containing a program code executable to deliver an output voltage or an output current from the mobile computing device to an igniter which converts the output voltage or the output current into heat sufficient to ignite a primer composition to generate flame spread in associated combustible materials.

### II. BACKGROUND

Mobile computing devices can be excellent alternative power sources because of their pervasive existence in the modern life. Mobile computing devices afford a user-friendly graphical interface, energy storage and power output, and a highly programable platform. Mobile computing device dependent applications have been developed to power various peripherals with the advantage of being compact size, low cost, and user friendly. However, to the best of our knowledge, smartphones have never been used as a mobile power station to ignite combustible materials.

### III. SUMMARY OF THE INVENTION

A broad object of particular embodiments of the invention can be to provide an igniter connectable to a mobile computing device configured to generate a current to activate the igniter to generate flame spread in combustible materials, wherein the igniter includes a power output cord having a connector configured to removably connect to the mobile computing device, a resistance wire electrically coupled to the power output cord to receive an output current from the mobile computing device to generate heat sufficient to ignite a primer composition and one or more of a combustible composition, a combustible overwrap or other combustible materials, and combinations thereof.

Naturally, further objects of the invention are disclosed throughout other areas of the specification, drawings, photographs, and claims.

### IV. BRIEF DESCRIPTION OF THE DRAWINGS

FIG. 1 is an illustration depicting a method of using an embodiment of a portable low voltage material combustion system.

FIG. 2 is a block diagram is a block diagram of an illustrative computer means, network means and computer-readable medium which provides computer-executable instructions to provide an embodiment of the portable low voltage material combustion system.

FIG. 3 is an illustration of an embodiment of a mobile computing device having a display surface depicting a graphical user interface which can receive indications to establish the voltage output values or current output values of the voltage or the current to be delivered to an igniter disposed in a combustible overwrap to ignite the combustible overwrap.

FIG. 4A is an illustration of an embodiment of an igniter disposed in an unfolded combustible overwrap .

FIG. 4B is an illustration of an embodiment of an igniter disposed in a folded combustible overwrap.

FIG. 5 is an illustration of an embodiment of an igniter disposed in a folded combustible overwrap and packaging overwrap which can be disposed in a mobile computing device case.

FIG. 6A is a front elevation view of an embodiment of an igniter.

FIG. 6B is a side elevation view of the embodiment of the igniter shown in FIG. 6A.

FIG. 7A is a front elevation view of an embodiment of an igniter.

FIG. 7B is a side elevation view of the embodiment of an igniter shown in FIG. 7A.

FIG. 8A is a front elevation view of an embodiment of an igniter.

FIG. 8B is a side elevation view of the embodiment of an igniter shown in FIG. 8A.

FIG. 9A is a front elevation view of an embodiment of the igniter.

FIG. 9B is cross section view 7B-7B shown in FIG. 8A.

### V DETAILED DESCRIPTION OF THE INVENTION

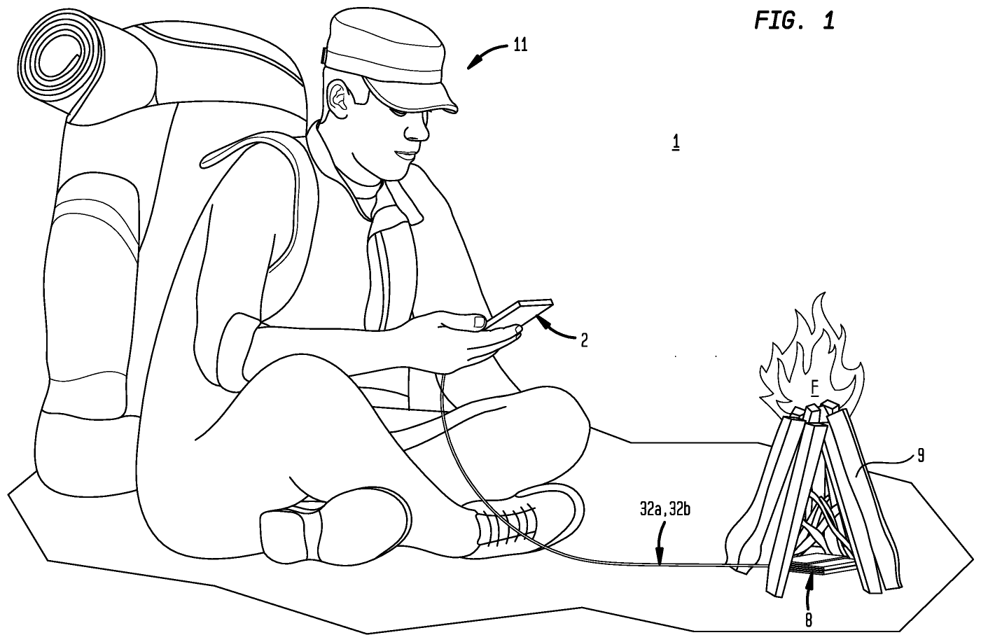

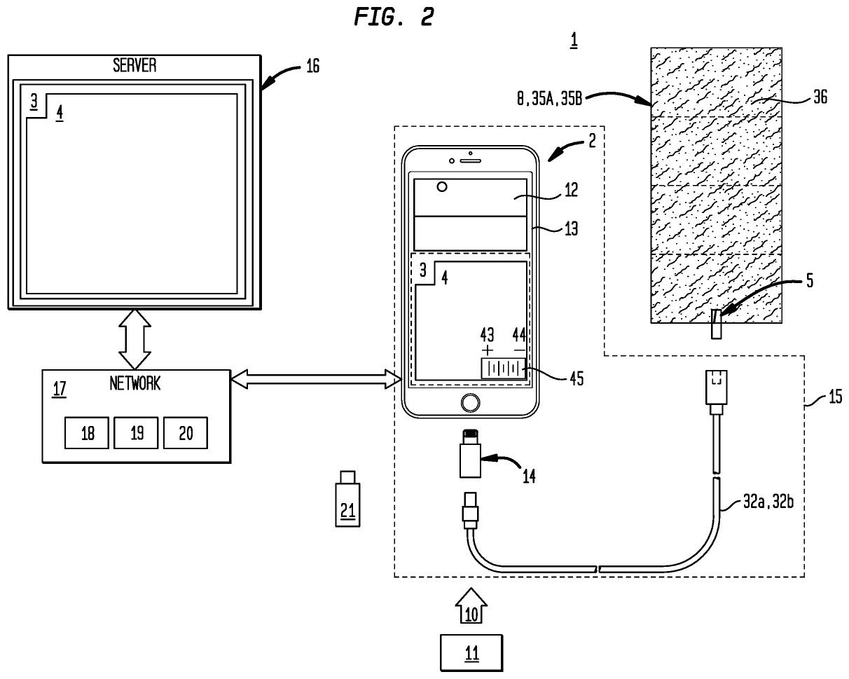

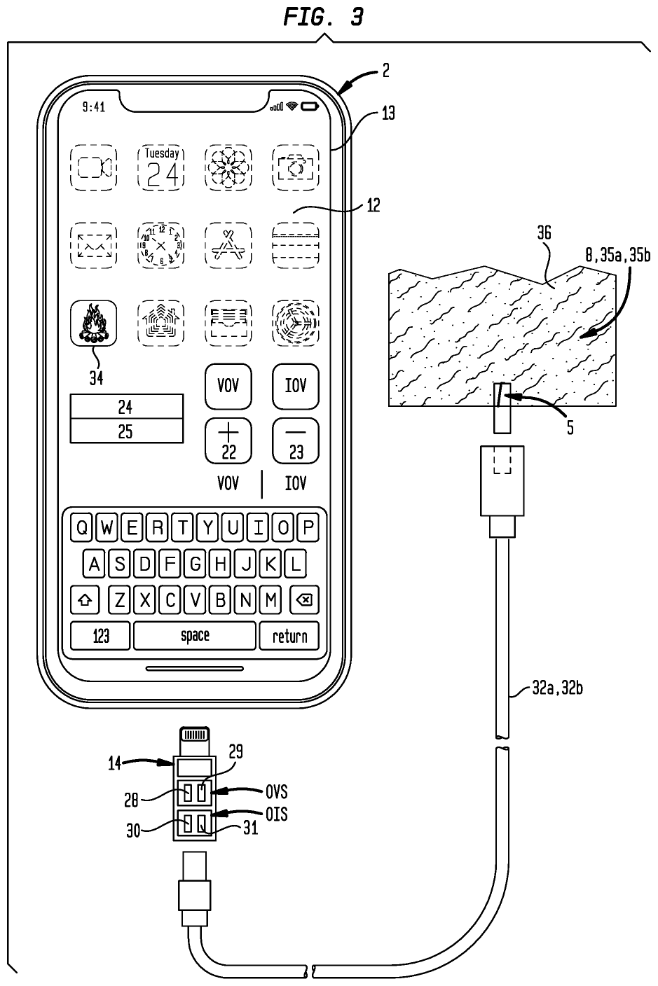

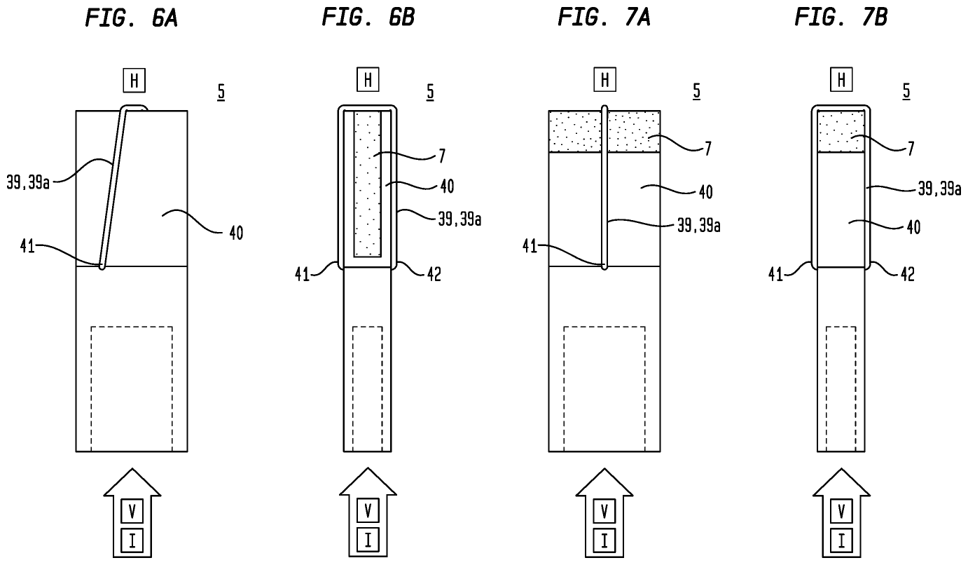

Referring to FIGS. 1 through 5, 6A, 6B, 7A, 7B, 8A and 8B, embodiments of a portable low voltage material combustion system (1) (also referred to as the “system”) and methods of making and using the system (1) are shown including a mobile computing device (2) including a non-transitory computer readable medium (3) containing a program code (4) executable to deliver an output voltage (V) or an output current (I)(as shown in the example of FIG. 2) from the mobile computing device (2) to an igniter (5) which converts the output voltage (V) or the output current (I) into heat (H) sufficient to ignite a primer composition (6) (as shown in the example of FIG. 6A). The igniter (5) can, but need not necessarily, include a combustion composition (7) which can, but need not necessarily be, associated with the primer composition (6) which combusts upon ignition of the primer composition (6) to afford a flame (F) which spreads about the igniter (5). The igniter (5) can further include a combustible overwrap (8) which can further burn upon combustion of the combustion composition (7). The ignitor (5) can be associated with other combustible material (9). The program code (4) can be executed by user indications (10) of a user (11) in a graphical user interface (12) depicted on a display screen (13) of a mobile computing device (2) to actuate the igniter (5) to initiate flame (F) spread in the primer composition (6) or the combustible composition (7)(as shown in the example of FIG. 3), or the combustible overwrap (8), and other combustible materials (9), and combinations thereof (as shown in the example of FIG. 1).

Now with primary reference to FIG. 2, in particular embodiments, the output voltage (V) or the output current (I) can be realized from a mobile computing device (2) by using a rationally designed universal serial bus (“USB”) on-the-go (“OTG”) module (14) and a downloadable mobile program code (4). By execution of the mobile program code (4) the output voltage (V) or the output current (I) can be delivered via the OTG module (14) to the igniter (5). The output voltage (V) and output current (I) can provide reliable ignition of an igniter (5) to initiate combustion of one or more of a primer composition (6), combustion composition (7), or combustible overwrap (8), and associated combustible material (9), and combinations thereof, depending upon the embodiment. The term “mobile computing device” means any device transported during normal usage, and without sacrificing the breath of the foregoing, includes portable computers, mobile phones, smartphones, wearable computers, personal digital assistants, lap top computers, tablet computers, slate computers, and carputers.

Currently, many mobile computing devices (2) include integrated OTG modules (14) (as shown in the example of FIG. 2) which allow the mobile computing devices (2) to function as a power workstation (15). Mobile computing devices (2) that do not include OTG modules (14) can be modified to function as a power workstation (15). The modification comprises two parts: the program code (4) that can be downloaded from a remote server (16) through a public network (17), such as the Internet (18), a cellular-based wireless network(s) (19), or a local network (20) (individually or collectively the “network”), or obtained on a discrete computer readable medium (21)(as examples: travel drive, flash drive, data stick, optical disc); and an OTG module (14) as hardware to be connected to the mobile computing device (2)(as shown in the example of FIG. 3). The program code (4) can be executed to depict a graphical user interface (12) on the display screen (13) of the mobile computing device (2) to control the the output voltage (V) or output current (I). Typically, currently available OTG modules (14) maintain output voltage (V) at 5V+/−5% while the output current (I) can be delivered in a range of about 0.8 milliamps “mA” to about 1.2 A.

Now, with primary reference to FIG. 3, modification of the mobile computing device (2) can allow the voltage output value (VOV) or the current output value (IOV) to be adjusted by user indications (10) in the graphical user interface (12). As one illustrative example, the computer code (4) can be executed to depict a plus icon (22) and a minus icon (23) or depict a voltage value input field (24) or a current value input field (25) for numerical entry of voltage output values (VOV) or current output values (IOV) from a virtual keyboard (26), and combinations thereof. The voltage output value (VOV) of a modified mobile computing device (2) can selected in the range of 0.0 V to about 5 V with an increment of about 0.1 V, while the current output value (IOV) can be selected in range of about 0.0 A to about 1.2 mA with increments of 0.1 mA. The output can be either voltage or current, but not both at the same time. While the example expresses units in volts or milliamps, the modification of the mobile computing device (2) can for certain applications express microvolts or microamps which can be selected in intervals of 0.1 microvolts or 0.1 microamps.

Again, with primary reference to FIG. 3, for those mobile computing devices (2) that do not include an OTG module (14), an example of a circuit of an OTG module (14) can include a microcontroller (27) (MCU) (an example being an STM32) and output voltage system (OVS) and output current systems (OIS). The voltage output system (OVS) can include a voltage source chip (28)(an example being a RT8008 1.5 MHz, 600 mA, PWM stepdown DC/DC converter) coupled with a first variable resistor (29) (an example being a MAX5484 10-bit, nonvolatile, linear-taper digital potentiometer) to adjust the output voltage (V). Similarly, the output current system (OIS) can include a current source chip (30) (an example being a LM334MX current regulator diode 400 mW) coupled with a second variable resistor (31) (an example being a MAX5483 10-bit, nonvolatile, linear-taper digital potentiometer) to adjust the output current (I). The OTG module (14) can be connected with the mobile computing device (2) and after OTG module (14) recognition by the mobile computing device (2), the program code (4) can then be opened, followed by the selection of the voltage output value (VOV) or the current output value (IOV). The output current (I) and the output voltage (V) may have discrete output power cords (32a, 32b). Thus, when the source output is switched from one to the other, the electrical connection may be changed accordingly. In mobile computing devices (2) that include an OTG module (14) that maintains a voltage output (V) of 5 V only, one output power cord (32a) need be utilized. In particular embodiments, the power cord (32a) can be integrated with the igniter (5). In particular embodiments, the program code (4) can establish a non-adjustable voltage output (V) of 5 V and a non-adjustable current output (I) of between about 0.4 mA and 1.2 mA providing sufficient current to ignite the igniter (5). After the connection of the mobile computing device (2) to the igniter (5), power can be delivered to the igniter (5) by user indications (10) in a current delivery icon (33) (shown in the example of FIG. 3 as a fire icon (34)).

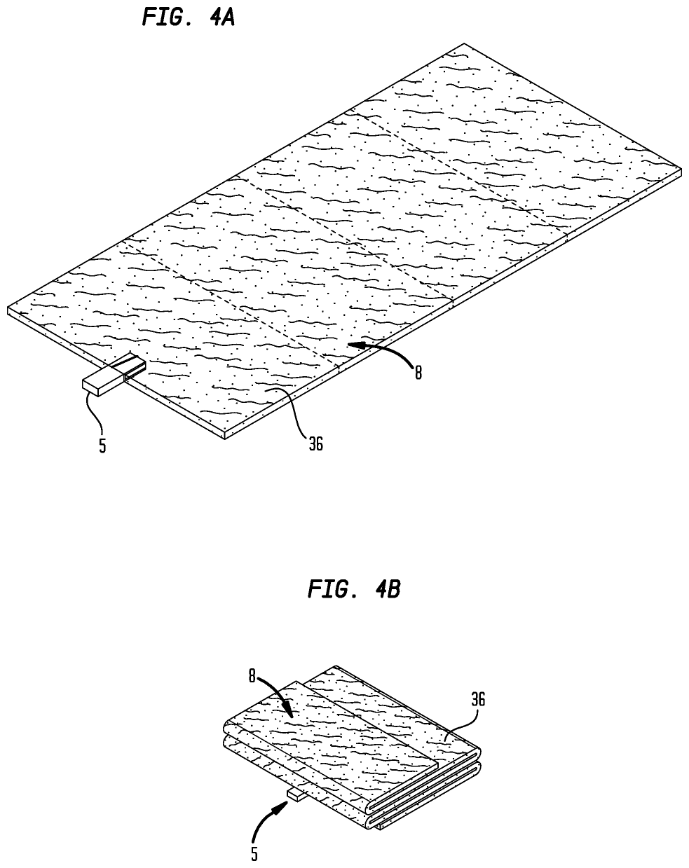

Now, with primary reference to FIGS. 4A and 4B, the apparatus can further include a combustible overwrap (8) disposed about the igniter (5). The combustible overwrap (8) can be associated with the igniter (5) which upon ignition can a burn time of about one to five minutes achieve flame (F) spread to other combustible material (9) (as shown in the example of FIG. 1 tinder or wood to start a fire). As illustrative examples, the combustible overwrap (8) can comprise a cotton fiber sheet (35a) or cellulose aerogel sheet (35b) which can, but need not necessarily, be infused with a flammable substance (36) (as an example, Stoddard solvent (CAS No.: 8052-41-3) (a shown in the example of FIG. 4A). In particular embodiments, the combustible overwrap (8) can be folded about the igniter (5) and further in an wrapper (37) (as shown in the example of FIG. 4B the wrapper can be of paper, foil, plastic, or the wrapper material).

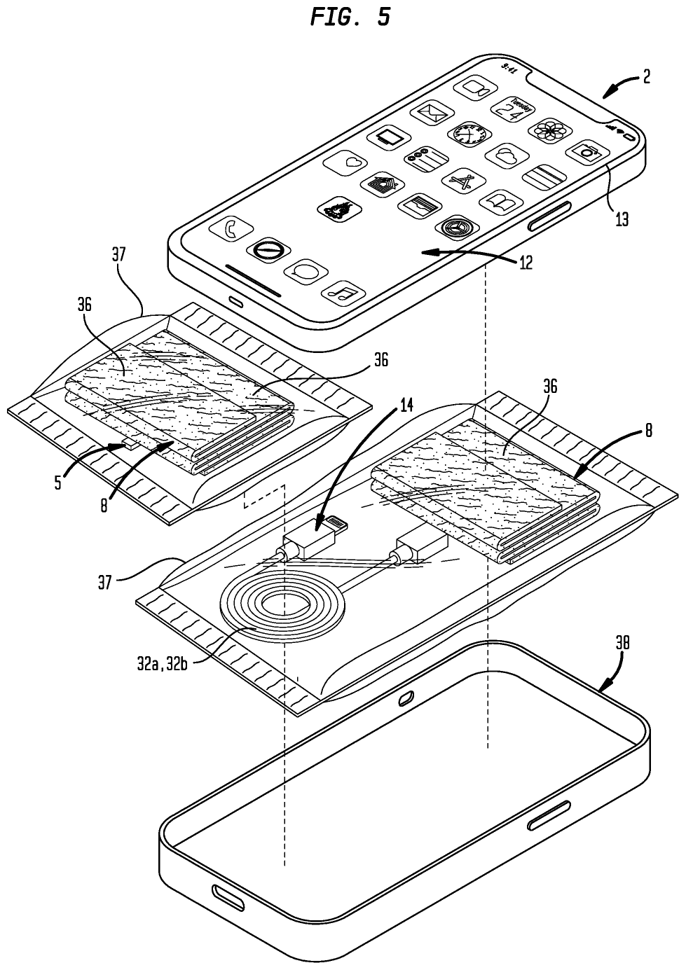

Now, with primary reference to FIG. 5, in particular embodiments the igniter (5) associated with one or more of an output power cord (32a, 32b), combustible overwrap (8), and wrapper (37) can afford an apparatus having spatial dimensions to allow storage between the mobile computing device (2) and a mobile computing device case (38). In particular embodiments, the igniter (5) with combustible overwrap (8) in the wrapper (37) may be only 2 millimeters (mm) to 4 mm in thickness.

Now, with primary reference to FIGS. 6A-6b, 7A-7b, 8A-8B, and 9A-9B, embodiments of the igniter (5) can include a resistance wire (39) which generates heat (H) under an output current (I). An example of a resistance wire (39) that can be used in embodiments of the igniter (5) can be a nichrome wire (39a) configured to receive the output current (I) to generate heat (H). In particular embodiments, resistance wire (39) under an output current (I) can achieve a temperature of about 90° C. (about 200° F.) or greater. As an example, a thin nichrome wire (39a) under an output current (I) occurring in the range of about 200 mA and about 1,500 mA can achieve a temperature of or in excess of 90° C. (about 200° F.) and in certain instances may reach the melting point of the wire of about 1400° C. (about 2500° F.). The example of a nichrome wire (39a) is not intended to preclude embodiments having a resistance wire (39) made from other material(s) that can generate heat (H) or achieve a temperature of about 90° C. (about 200° F.) or greater under the output current (I).

Again, with primary reference to FIGS. 6A-6b, 7A-7b, 8A-8B, and 9A-9B, the resistance wire (39, 39a) can be disposed in or on an insulator (40) and the resistance wire first end (41) and the resistance wire second end (42) can be respectively electrically coupled to the positive and negative terminals (43)(44) of the power source (45) afforded via the OTG module (14) of the mobile computing device (2).

In the examples shown in FIGS. 6A-6B and 7A-7B, the insulator (40) can be a non-electrically conductive material (40a) on which the resistance wire (39) can be wrapped over with the resistance wire first and second ends (43, 44) correspondingly connected to the pair of conductors (46, 47) of the output power cord (32a, 32b).

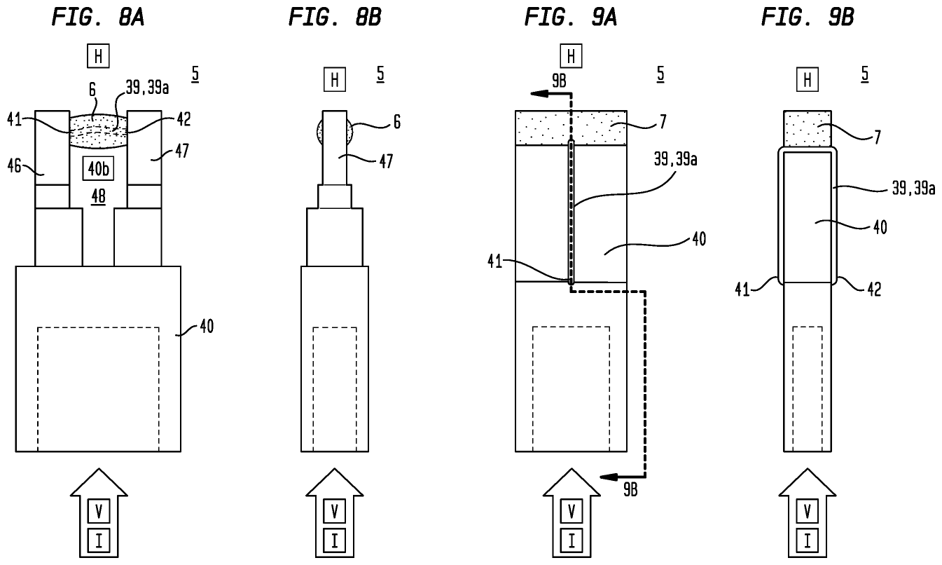

As shown in the example of FIGS. 8A-8B, the insulator (40) can be air (40b) about the resistive wire (39) bridging a gap (48) between the resistance wire first and second ends (43)(44) correspondingly connected to one of a pair of conductors (46, 47) of the output power cord (32a, 32b).

Again, with primary reference to FIGS. 6A-6b, 7A-7b, 8A-8B, and 9A-9B, the ignitor (5) can further include a heat sensitive primer composition (6) which can coat the resistance wire (39). The primer composition (6) can have a flash point and autoignition temperature which allows ignition of the primer composition (6) upon delivery of the output current (I) to the resistive wire (39). Examples of primer compositions (6) suitable for use in embodiments of the invention can be black powder (also known as gunpowder) mixed with nitrocellulose lacquer to achieve a thickened fluid (syrup consistency), or a mixture of 75% potassium chlorate (200 mesh or finer) and 25% charcoal (airfloat) mixed with nitrocellulose lacquer to achieve a thickened fluid, or a mixture of 5 grams potassium chlorate (200 mesh or finer) and 5 grams antimony trisulfide (200 mesh or finer) with addition of nitrocellulose lacquer to achieve a thickened fluid. The thickened fluid can be applied to the resistive wire (39) and allowed to dry to afford the primer composition (6). Particular embodiments of the primer composition (6) can ignite when the resistive wire (29) achieves a temperature in excess of about 90° C. (about 200° F.).

Now, with primary reference to FIGS. 9A-9B, in particular embodiments, the igniter (5) can further include a combustion composition (7) contacting or overcoating the primer composition (6). The combustion composition (7) does not ignite spontaneously but can be ignited by corresponding ignition of the primer composition (6). The combustion composition (7) can induce flame (F) spreading in the insulating material (40) of the igniter (5), the combustible overwrap (8), the wrapper (37) or in other associated combustible materials (10). The combustion composition (7) can comprise a mixture of potassium chlorate, sulfur and a binder. The mixture can be similar to the composition used to produce match heads. The combustion composition (7) can be disposed to contact the primer composition (6) as shown in FIGS. 6A-6B, 7A-7B or can be disposed about the end of the igniter (5), as shown in FIGS. 9A-9B, and allowed to dry.

As can be easily understood from the foregoing, the basic concepts of the present invention may be embodied in a variety of ways. The invention involves numerous and varied embodiments of a portable low voltage material combustion system and methods for making and using such a portable low voltage material combustion system including the best mode.

As such, the particular embodiments or elements of the invention disclosed by the description or shown in the figures or tables accompanying this application are not intended to be limiting, but rather exemplary of the numerous and varied embodiments generically encompassed by the invention or equivalents encompassed with respect to any particular element thereof. In addition, the specific description of a single embodiment or element of the invention may not explicitly describe all embodiments or elements possible; many alternatives are implicitly disclosed by the description and figures.

It should be understood that each element of an apparatus or each step of a method may be described by an apparatus term or method term. Such terms can be substituted where desired to make explicit the implicitly broad coverage to which this invention is entitled. As but one example, it should be understood that all steps of a method may be disclosed as an action, a means for taking that action, or as an element which causes that action. Similarly, each element of an apparatus may be disclosed as the physical element or the action which that physical element facilitates. As but one example, the disclosure of an “igniter” should be understood to encompass disclosure of the act of “igniting”—whether explicitly discussed or not—and, conversely, were there is a disclosure of the act of “igniting”, such a disclosure should be understood to encompass disclosure of a “igniter” and even a “means for igniting.” Such alternative terms for each element or step are to be understood to be explicitly included in the description.

In addition, as to each term used it should be understood that unless its utilization in this application is inconsistent with such interpretation, common dictionary definitions should be understood to be included in the description for each term as contained in the Random House Webster's Unabridged Dictionary, second edition, each definition hereby incorporated by reference.

All numeric values herein are assumed to be modified by the term “about”, whether or not explicitly indicated. For the purposes of the present invention, ranges may be expressed as from “about” one particular value to “about” another particular value. When such a range is expressed, another embodiment includes from the one particular value to the other particular value. The recitation of numerical ranges by endpoints includes all the numeric values subsumed within that range. A numerical range of one to five includes for example the numeric values 1, 1.5, 2, 2.75, 3, 3.80, 4, 5, and so forth. It will be further understood that the endpoints of each of the ranges are significant both in relation to the other endpoint, and independently of the other endpoint. When a value is expressed as an approximation by use of the antecedent “about,” it will be understood that the particular value forms another embodiment. The term “about” generally refers to a range of numeric values that one of skill in the art would consider equivalent to the recited numeric value or having the same function or result. Similarly, the antecedent “substantially” means largely, but not wholly, the same form, manner or degree and the particular element will have a range of configurations as a person of ordinary skill in the art would consider as having the same function or result. When a particular element is expressed as an approximation by use of the antecedent “substantially,” it will be understood that the particular element forms another embodiment.

Moreover, for the purposes of the present invention, the term “a” or “an” entity refers to one or more of that entity unless otherwise limited. As such, the terms “a” or “an”, “one or more” and “at least one” can be used interchangeably herein.

Further, for the purposes of the present invention, the term “coupled” or derivatives thereof can mean indirectly coupled, coupled, directly coupled, connected, directly connected, or integrated with, depending upon the embodiment.

Additionally, for the purposes of the present invention, the term “integrated” when referring to two or more components means that the components (i) can be united to provide a one-piece construct, a monolithic construct, or a unified whole, or (ii) can be formed as a one-piece construct, a monolithic construct, or a unified whole. Said another way, the components can be integrally formed, meaning connected together so as to make up a single complete piece or unit, or so as to work together as a single complete piece or unit, and so as to be incapable of being easily dismantled without destroying the integrity of the piece or unit.

Thus, the applicant(s) should be understood to claim at least: i) each of the portable low voltage material combustion system herein disclosed and described, ii) the related methods disclosed and described, iii) similar, equivalent, and even implicit variations of each of these devices and methods, iv) those alternative embodiments which accomplish each of the functions shown, disclosed, or described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, ix) methods and apparatuses substantially as described hereinbefore and with reference to any of the accompanying examples, x) the various combinations and permutations of each of the previous elements disclosed.

The background section of this patent application, if any, provides a statement of the field of endeavor to which the invention pertains. This section may also incorporate or contain paraphrasing of certain United States patents, patent applications, publications, or subject matter of the claimed invention useful in relating information, problems, or concerns about the state of technology to which the invention is drawn toward. It is not intended that any United States patent, patent application, publication, statement or other information cited or incorporated herein be interpreted, construed or deemed to be admitted as prior art with respect to the invention.

The claims set forth in this specification, if any, are hereby incorporated by reference as part of this description of the invention, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent application or continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon. The elements following an open transitional phrase such as “comprising” may in the alternative be claimed with a closed transitional phrase such as “consisting essentially of” or “consisting of” whether or not explicitly indicated the description portion of the specification.

Additionally, the claims set forth in this specification, if any, are further intended to describe the metes and bounds of a limited number of the preferred embodiments of the invention and are not to be construed as the broadest embodiment of the invention or a complete listing of embodiments of the invention that may be claimed. The applicant does not waive any right to develop further claims based upon the description set forth above as a part of any continuation, division, or continuation-in-part, or similar application.

1. An apparatus, comprising:
an igniter including:
a power output cord having a connector configured to removably connect to a mobile computing device configured to generate and output current;
a resistance wire electrically coupled to said power output cord to receive an output current from said mobile device to generate heat;
a primer composition ignited by said heat generated by said resistance wire; and
a combustible overwrap ignited by ignition of said primer composition.

2. The apparatus of claim 1, wherein said output current occurs in a range of about 0.8 mA and about 1.2 A.

3. The apparatus of claim 2, wherein said output current occurs in a range of about 400 mA and about 800 mA.

4. The apparatus of claim 1, wherein said resistive wire generates said heat having a temperature at or above 90° C. (about 200° F.).

5. The apparatus of claim 4, wherein said resistive wire comprises a nichrome wire.

6. The apparatus of claim 1, wherein said primer composition ignites at a temperature of at or above 90° C. (about 200° F.).

7. The apparatus of claim 1, wherein said primer composition applied to said resistive wire and allowed to dry.

8. The apparatus of claim 7, wherein said primer composition comprises black powder combined with nitrocellulose lacquer to achieve a thickened fluid.

9. The apparatus of claim 7, wherein said primer composition comprises a mixture of 75% potassium chlorate and 25% charcoal by weight combined with nitrocellulose lacquer to achieve a thickened fluid.

10. The apparatus of claim 7, wherein said primer composition comprises a mixture of 50% potassium chlorate and 50% antimony trisulfide by weight combined with nitrocellulose lacquer to achieve a thickened fluid.

11. The apparatus of claim 1, wherein said mobile device includes an on-the-go module configured to deliver a current of between about 0.8 mA and about 1.2 A at constant voltage.

12. The apparatus of claim 11, wherein said on-the-go module configured to deliver a current of between about 400 mA and about 800 mA at constant voltage.

13. The apparatus of claim 1, further comprising an on-the-go module coupled to said mobile computing device comprising a microprocessor containing a program code executable to operate a current regulator diode coupled to a variable resistor which operates to adjust said output current or a DC/DC convertor coupled to a variable resistor which operates to adjust said output voltage.

14. The apparatus of claim 13, wherein said on-the-go module configured to deliver a current of between about 0.8 mA and about 1.2 A at constant voltage.

15. The apparatus of claim 14, wherein said on-the-go module configured to deliver a current of between about 400 mA and about 800 mA at constant voltage.

16. The apparatus of claim 13, wherein said program code further executable to display a graphical user interface on a display surface of said mobile computing device, wherein said graphical user interface depicts a combustion icon which by user indications actuates said program code to generate said output current in said power output cord coupled to said igniter.

17. The apparatus of claim 16, wherein said program code further executable to depict a current delivery icon in said graphical user interface which by user indications actuates said program code to allow entry of a current output value of said output current generated by said on-the-go module.

18. The apparatus of claim 16, wherein said program code further executable to depict a voltage delivery icon in said graphical user interface which by user indications actuates said program code to allow entry of a voltage output value of said output voltage generated by said on-the-go module.

19. The apparatus of claim 1, further comprising a combustion composition disposed on said igniter ignitable by said primer composition.

20. The apparatus of claim 19, wherein said combustion composition comprises a mixture of potassium chlorate, sulfur and a binder.

21. The apparatus of claim 1, wherein said combustible overwrap comprises a cellulose fiber sheet or cellulose aerogel.

22. The apparatus of claim 21, wherein said combustible overwrap further infused with a flammable substance.

23. The apparatus of claim 22, wherein said flammable substance comprises a stoddard solvent.
